(19) United States
(12) Patent Application Publication
(10) Pub. No.: US 2010/0249994 A1
(43) Pub. Date: Sep. 30, 2010

(54) EXPRESS CHECKOUT METHOD AND APPARATUS

(76) Inventor: Craig Sinclair, Lake Forest, IL (US)

Correspondence Address: ROSENBAUM & SILVERT, P.C., 1480 TECHNY ROAD, NORTHBROOK, IL, 60062, US

(21) Appl. No.: 12/414,625

(22) Filed: Mar. 30, 2009

(51) Int. Cl. G06K 15/02; G06F 17/00; G06Q 10/00; A47F 1/04; B65G 59/00

(52) U.S. Cl. 700/232; 700/231; 211/59.2; 221/1; 235/383; 705/1.1

(57) ABSTRACT

Provided herein are systems, methods, and compositions for an express checkout vending machine that includes an input unit, a video display screen, and a communication unit. The vending machine also includes a dispensing unit adapted to receive and internally bag self-purchase items.

### FIELD OF THE INVENTION

The present invention relates in general to the art of mechanized merchandizing and, in particular, relates to the design and structure of a vending machine linked electronically to a server that is usefully employed in the display and sales of small, highly valuable products.

### BACKGROUND

Small but high value goods that are prone to theft, such as razor blades, expensive over-the-counter drugs, and electronic items and supplies, among many others, are typically stored in locked displays. Only after locating a sales clerk may a consumer view and purchase these items. For example, a consumer who wants to view and purchase an item housed in a locked display must first locate a sales clerk. The sales clerk must then access the keys and open the locked display. With the assistance of the sales clerk, the consumer may view and then purchase the item.

In another example, a retailer of high- to low-value items may provide open access to only a photograph and description of its high-value items. The consumer may view the photograph and read the description, but must purchase the item by finding a sales clerk who then delivers the product to the consumer.

In yet another example, a retailer may place the high-value items behind a counter and the consumer may not realize that the store even offers the product for sale.

Each of these examples illustrate that purchasing a small, high value item can be time consuming for both the sales clerk and consumer. From the consumer's perspective, it may not be evident that the item of interest is even available; from the store's perspective, sales will certainly be lost.

### SUMMARY OF THE INVENTION

The present invention is an express checkout vending machine that is adapted for shelf use in a store, although different embodiments demonstrate the use of the claimed vending machine in wall- or rack-mounted forms as well as a stand-alone form that may be placed anywhere space allows in a store. The vending machine includes an input unit for intaking information and queries from a customer, an output unit for imparting information to or directing the customer to respond in specific manners, and a communication unit for electronically connecting the various components of the express checkout vending machine itself as well as to external sources of information and instruction. In one embodiment, the input unit includes a reading device that reads one or more of a magnetic strip, a barcode, or a chip. In another embodiment, or the same embodiment, the output unit is a visual display that is capable of displaying still or moving graphics or photos, including video-based still or moving graphics or photos; such a visual display can be a cathode ray tube, a liquid crystal display, a plasma display, or any other display usefully employed as a monitor for a computer-based output of data. The communication unit can connect electronically by means of hard-wired connections or wireless connections or both, as appropriate to the situation presented. The vending machine also includes a dispensing unit adapted to receive and internally bag self-purchase items.

In another embodiment of the present invention, the express checkout vending machine includes a means for receiving and displaying self-purchase items, a means for bagging self-purchase items within the vending machine prior to bagged self-purchase items being dispensed; and a means for dispensing one or more bagged self-purchase items.

In yet another embodiment of the present invention, a method for dispensing a self-purchase item is set forth, which method includes receiving a payment for the self-purchase item, placing into a bag the self-purchase item prior to dispensing, and dispensing one or more self-purchase items in the bag.

### BRIEF DESCRIPTION OF THE DRAWINGS

FIG. 1 is a perspective view of the physical form of one embodiment of the present invention.

FIG. 2 is a block diagram of communications between elements encompassed in one embodiment of the present invention.

FIG. 3 is a block diagram flow chart illustrating the operation of one embodiment of an express checkout apparatus and method therefor.

FIG. 4 is a perspective view of the interior elements of one embodiment of the present invention.

FIG. 5 is a section view of the interior elements of one embodiment of the present invention.

### DETAILED DESCRIPTION OF THE PREFERRED EMBODIMENTS

The methods, apparatuses, and systems can be understood more readily by reference to the following detailed description of the methods, apparatuses, and systems included therein and to the Figures and their previous and following description. Some, but not all, embodiments of the present invention are shown. The invention described here may be embodied in many different forms and should not be construed as limited to the embodiments disclosed here, which are merely presented to satisfied certain legal requirements. Like numbers refer to like elements throughout this disclosure.

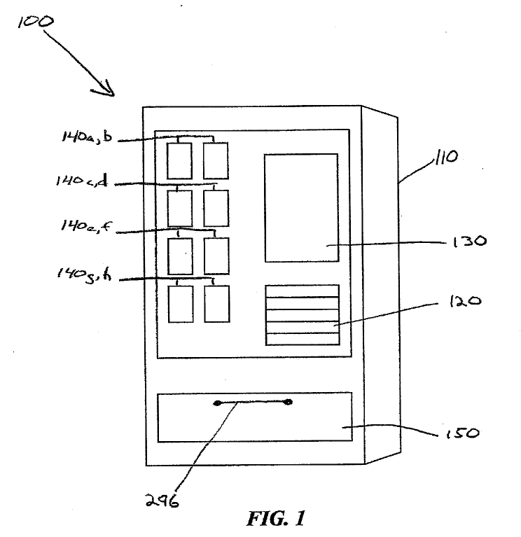

FIG. 1 shows a perspective view of the physical form of one embodiment of the present invention. The express check out vending machine 100 comprises a dispensing unit 110 adapted to receive and internally bag self-purchase items. A self-purchase item can be any product that a store keeper decides to protect by keeping behind a counter or within a locked or otherwise secure display case or out of sight completely but for employing the express check out vending machine of the present invention by which to display and sell the product. The outside dimensions of the vending machine 100 can be of any size suitably used in a store setting, however it is preferred in many embodiments that the vending machine have dimensions that allow it to be situated within a section of an inline merchandizing structure common to retail stores. Accordingly, in one embodiment, the dimensions of the front face of the vending machine facing an aisle within a store are preferably about 72 inches by about 40 inches, more preferably about 66 inches by about 36 inches. In another embodiment, the dimensions of the front face are about 60 inches by about 36 inches. Where the inline merchandizing structure has sections that accommodate about 30 inches laterally, the preferred vending machine outer dimension of its width is about 30 inches; and for inline merchandizing structures have 36 inch wide sections, the preferred vending machine outer dimension width is about 36 inches. Alternative preferred embodiments have widths that are between about 40 inches and about 12 inches, inclusive of all widths in between. Accordingly, the width can be about 33 inches, about 27 inches, about 24 inches, about 21 inches, about 18 inches, about 15 inches, and about 12 inches. The height of the front face of the vending machine 100 can be any height from about 72 inches down to about 24 inches, and any height in between. Accordingly, the height can be about 66 inches, about 60 inches, about 54 inches, about 48 inches, about 42 inches, about 36 inches, about 30 inches, and about 24 inches. The depth of the vending machine can also have varying preferred dimensions depending on the sort of product to be vended therefrom. However, generally, it is contemplated that the depth will encompass no more than the depth of a standard inline merchandizing structure. Accordingly, the depth of the vending machine 100 is preferably between about 42 inches and about 12 inches, and any depth in between. Preferred depth dimension includes about 15 inches, about 18 inches, about 21 inches, about 24 inches, about 27 inches, about 30 inches, about 33 inches, about 36 inches, and about 39 inches. An objective of the design of the express checkout vending machine 100 is to keep it a portable unit such that one or at most two people are required to move it around the store to different locations.

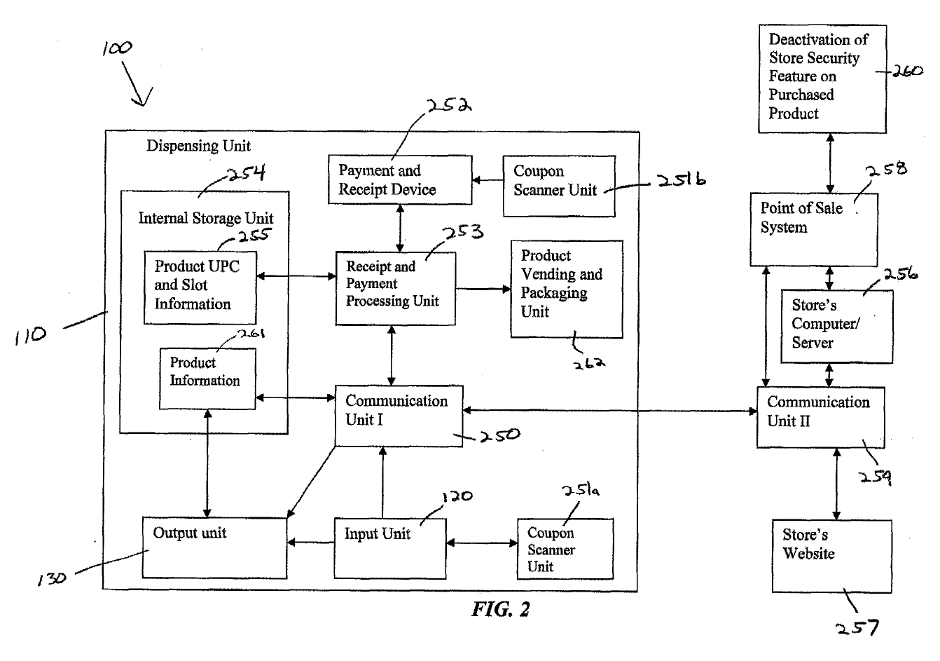

The machinery and electrical circuitry usefully adapted to the functions of dispensing a given self-purchase product and bagging same are not shown in detail here, however these components are well known to those skilled in the art and can be accomplished in a number of alternative embodiments as are well known in the art. See, for example, the following exemplary patents that disclose various aspects of the present invention in significant detail concerning the various individual components of the present invention, albeit no one or group of said prior patent publications discloses or suggests the present invention. Each of these patent publications is incorporated herein by reference with respect to the respective identified portions thereof: U.S. Patent Application 2002/0077724, directed at a vending machine that incorporates credit card verification in real time, incorporated herein with respect to FIGS. 2A. 2B, 3A, 3B, 4A, 4B, and 5, and Paragraphs 38, 39, and 56 to 65 thereof; U.S. Patent Application 2005/0154644, directed at vending machines in communication with a remote content server, incorporated herein in its entirety; U.S. Pat. Nos. 6,394,309, 5,442,898, and 4,989,391, directed at vending machines that dispense bagged product, incorporated herein in their respective entireties; U.S. Pat. No. 5,117,407, directed at a vending machine that includes a video and audio output, incorporated herein in its entirety. These and other disclosures in the art, as informed by this disclosure, provide support for the use and manufacture of vending machines in accordance with the present invention.

The vending machine 100 also comprises an input unit 120 through which a user can input information relating to an intended purchase or relating to programming functions built into the vending machine 100. The input unit 120 can be a keyboard that is alphanumeric or alpha only or numeric only, a touch sensitive surface for inputting script language or selecting pre-defined inputs, a bar code reader, a chip reader, a magnetic strip reader, a transponder sensor, a microphone to receive audible input, or a combination of two or more of these various input mechanisms, all of which are well known to the art. The bar code reader, chip reader, magnetic strip reader, or transponder sensor can recognize appropriately embedded information contained on or in a device that includes, respectively, a bar code, a chip, a magnetic strip, or a transponder, which device can be made of any suitable material that maintains the integrity of the embedded information and can be conveniently transported. Suitable materials include paper and card stock as well as plastic formed into a credit card type structure.

The keyboard of the present invention can be organized as a standard “qwerty” keyboard or an alphanumeric series of keys organized alphabetically for the letters; the numerals can be a line of 1 to 9 followed or preceded by 0, or a 3×3 keypad of the nonzero numerals with an offset 0; in another embodiment, a subset of letters or numerals is employed, i.e., the full set of 26 letters and 10 numerals need not be employed to have a fully functional input unit 120. With the keyboard input mechanism, the system of the vending machine can involve a customer requesting information about a particular product, entering selection upon deciding to buy a particular product, entering his/her identification and payment information, and indicating intention to take delivery on the spot or request delivery by posting to an address also entered into the input unit 120.

The vending machine 100 in some embodiments is adapted to accept payment by inserting currency, presented as paper or coin or both, and, in turn, provide change therefor. Accordingly, such embodiments include a currency- and coin-accepting device (not shown). Also provided on such embodiments is a change dispenser. Some units may accept paper currency only and credit change to an account that the customer inputs into the input unit 120, which account information may relate to a credit card, store credit, even bank account. The approaches that one can place into the method of payment and receipt of change, if needed, is as great as the many ways society has for moving money between institutions and into individually identified accounts.

In yet another embodiment, a customer enters purchase-related information onto a website connected to the store where the vending machine is located and upon arriving at the location of the express checkout vending machine 100 enters into the input unit 120 a code received from the web site after completing a purchase online and thereby receives the product without any need for further human intervention apart from that of the customer alone. The flexibility of the system of the present invention accommodates many approaches to purchasing and delivery, as indicated by the plethora of potential inputs into the input unit 120 noted above, with or without prior inputs entered online from a remote site relative to the site of the vending machine 100.

The express checkout vending machine 100 also includes an output unit 130; and in some embodiments, multiple output units 130 are employed. The output unit 130 is any device for presenting information to a user at the site of the vending machine 100. For example, one can receive information by reading a display screen, such as a video screen having a cathode ray tube, liquid crystal display, plasma screen, or other design appropriately set up as a visual screen. Other output devices include printers for provisioning of hard copy output or a speaker for provisioning of oral output (not shown). In one embodiment, the present invention early in a given use asks orally if the user desires oral input and output, as would be usefully employed by one with vision impairment, in which case text recognition algorithms known to the art are employed in response to defined questions to achieve appropriate inputs and outputs of information that facilitates the efficient use of the present invention even by one having impaired sight.

The sort of information that may be presented by the output unit 130 include, but is not limited to, any and all information commonly included on standard product packaging, including detail sometimes referred to as back panel information. Additionally, other related information that may be presented by the output unit 130 can be articles and other information relating to the product that, for example, may be downloaded from an internet link. Even competitive information relating to alternative products may be displayed in some embodiments. As noted, the output unit can also include a separate printer (not shown) that prints a receipt upon purchase of a product that can be taken by the customer. In other embodiments, the receipt print function is situated internally in the vending machine (not shown) such that the receipt is included in the bag in which the product is placed and then the bag is sealed, as further described below.

The inclusion of the receipt in the bag with the product can be accomplished in various manners and readily included as a design choice by those of skill in the art. One embodiment contemplated for the instant invention is to dispose the printer of the receipt and payment processing unit 253 such that the printed receipt is dispensed from the printer along the path defined by the chute 278 or its alternative embodiment, a conveyor belt, such that the printed receipt necessarily contacts the back side of the receipt. The back side of the receipt shall have received a discrete amount of a tacky but not permanently adhering substance, such as that which holds releasable sticking notes to a surface, as it is dispensed from the printer of the receipt and payment processing unit 253. Accordingly, as the product and the back side of the receipt come into contact, the receipt releasably sticks to the product and thus enters the bag with the product.

Another feature included in many embodiments of the present invention is one or more display units 140a-h. Each display unit can be a repository of a sample of the physical product, or the very physical product to be dispense to the next purchaser, protected by a translucent glass or plastic, thereby allowing a customer to inspect the actual product prior to purchase. The display unit or units can, in the alternative, be display screens as described above with regard to the output unit 130 wherefrom the product(s) sold from vending machine 100 are shown in one or more views in sequence, as in front, back, top, and the like. In some embodiments, the product may be displayed on a display unit 140 such that it rotates through 360°, and further may present such display along each of three axes defining the three-dimensionality of the product. Software for providing such capability is known in the art and readily employed by skilled artisans in this area. A further feature included in some embodiments of the present invention allows the customer to request that the display unit rotate the product in ways requested at the customer's direction by use of the input unit 120.

Either the output unit 130 or the display unit 140, presuming that the display unit in the embodiment discussed in this context is a display screen as described above, can be employed to convey photographs or drawings of products being considered by the customer. In view of the fact that many packaging designs of products keep the look of a product hidden from view, such display by the output unit 130 and/or display unit 140 will be a welcome addition for a customer's evaluation. Additionally, the customer may thereby evaluate the size, strength, color, warranty, and other features and aspects of a given product, including back panel and use instructions. Another category of information presented in this fashion may include short demonstrations of the product's utility or operation, such as, for example, demonstrating procedures hitherto not encountered or rarely encountered, such as new methods for taking a child's temperature or other procedures more associated with professional persons rather than lay persons, as just one example.

Such information would be included in an internal memory device or would be accessible by communication to an external memory device. The internal memory device would also relate the input from the customer to purchase a given product to cause the product situated in a given storage container within the vending machine 100, commonly referred to as a vending slot, that would be identified by the appropriate button or code selected by the customer. Access to the aforementioned information is not necessarily constrained by the decision to purchase. Instead, it is available from the vending machine by a customer seeking such information prior to a decision to purchase the product.

The vending machine 100 of the present invention also includes a communication unit (not shown in FIG. 1). The communication unit facilitates in and out communications with a server of the store, and can communicate by wired or wireless means as are well known in the art. The communication unit, as further described below, also communicates with the input unit 120, the output unit 130, and internal memory units (not shown) that store information relating to product information, and the like.

Another internal feature of the vending machine facilitates the movement of product from storage unit to bagging and ultimately out the port to the waiting customer. In many embodiments, this movement through the internal reaches of the vending machine is facilitated by a standard screw or curl device as known in the art. Such a device provides flexibility to hold product of various sizes and shapes, to transport such product, and to bag with receipt, if to be so included, seal, and release such product to the paying customer. Without entering into detail on such design that is well-known in the art, and to the extent that the claims of the present invention do not require enablement of the mechanics of the internal workings of the vending machine, the description of this aspect of the vending machine relies on the well known prior art as practiced by skilled artisans.

One other feature common to the vending machine 100 of the present invention is the port 150 through which the bagged product emerges from the vending machine 100 once the purchase is complete and delivery requested.

Whereas the embodiment of the vending machine 100 shown in FIG. 1 is a vertically oriented rectangular unit, the shape of the unit is wholly immaterial to the functioning of the device. Different embodiments can be a horizontally oriented rectangular unit, as for fitting on inline three foot or four foot display fixtures commonly used in a retail store. Square units are equally usefully employed, as are less common shapes that may be employed for purposes of attracting attention from customers, such as parallelogram, ovoid, or circular designed vending units. Moreover, the positioning of the noted elements of the input unit 120, the display unit(s) 140, the output unit(s) 130, and the port 150 need not reflect the positions these elements are shown to occupy in the vending machine 100 shown in FIG. 1.

The materials usefully employed in manufacturing a vending machine of the present invention are contemplated to be of lighter materials, such as plastic and aluminum. As the intended use of the vending machine is in a protected, non-isolated environment within a retail store, there is less concern for the level of security required for isolated vending machines, particularly those situated out of doors and exposed to the elements. Moreover, in many embodiments of the present invention, the portability of the vending machine is an advantage for ease of placement onto existing shelving or rack systems, and for moving individual vending machines to different places within the store, or between stores.

For some embodiments, the vending machine is contemplated to be constructed in a manner that will facilitate its attachment to a standard end stand display. A further alternative for its placement in a store is to attach a common base or feet such that the vending machine can be used as a freestanding display anywhere in a store. A yet further alternative of the design of the vending machine is to include hand grips to allow ease of movement of each unit to different locations within a store. It is also contemplated that some embodiments of the vending machine will include secure attachments to fixed positions in the store such as, for example, a locking mechanism the connects the vending machine to the inline merchandizing structure to which shelving and other display components are attached in a store.

At this point, it is helpful to present how the express checkout vending machine may be employed prior to a discussion of the underlying logic of functions that are included in the present invention. In one typical use, a customer enters a retail store seeking to purchase a product of smaller size and higher value, such as a wrist watch, although of course the product can be any product of small size, meaning packageable in less than about eight cubic inches, or less than about six cubic inches, or less than about four cubic inches, or less than about two cubic inches, or less than about one cubic inch. Alternatively, the longest dimension of a product sold by the vending machine of the present invention is no greater than about eight inches, no greater than about six inches, no greater than about four inches, no greater than about two inches, or no greater than about one inch. The customer finds the location of a vending machine that includes a selection of the product of interest, inputs his request into the input unit 120, requests information regarding the warranty or depth of water tolerance or other useful characteristics commonly provided for the product of interest, and views the appropriate display unit 140. The customer ultimately decides to purchase the product and indicates his decision using the input unit 120 and pushes a particular button associated with the product of interest or keys in a code therefor or voices the choice by saying a code or name of the product, as instructed by the output unit 130. The customer would then enter information relating to possible discounts, such as a manufacturer's coupon, that may be entered by displaying the coupon to a bar code reader, which may include inserting the coupon into a slot for reading and disposing of the coupon. If available, the customer may also input information relating to a loyalty program, which can be accomplished using a smart card having a transponder included, a loyalty card having a magnetic strip or a bar code, for example, that includes embedded information about the customer. The output unit 130 would then display the payment required. In response, the customer would choose a form of payment including, for example, credit or debit using a credit or debit or smart card inserted into the appropriate slot for reading of same or keying in said information into the input unit 120, if the store accepted such information in that format, or cash using currency inserted into a slot for accepting cash. These approaches to payment, including the underlying hardware and software components required therefor, are well known in the art and can be readily constructed and employed by those skilled in the art.

The present invention rests on the combination of these known elements, which prior to now have not appeared together in a single vending machine. The present invention not only presents information about the product being vended thereby, and not only is capable of interacting with the customer in presenting the information, and not only accepts payment, and optionally issues change, but it also issues the purchased product in a sealed bag that optionally includes the receipt.

The electronic connections that allow for the successful combination of these various features of the vending machine of the present invention is set forth in FIG. 2, presented here to illustrate one embodiment of the present invention. The express checkout vending machine 100 includes, at minimum, an input unit 120, an output unit 130, which in this particular embodiment is a video display screen, a communication unit 250, and a dispensing unit 110 that is adapted to receive and internally bag self-purchase items. The dispensing unit 110 is depicted in FIG. 2 as encompassing all other components that are included in the express checkout vending machine, which include necessarily included elements as indicated above as well as optionally included elements, which are further described below. Indeed, the dispensing unit 110 certainly will include the basic elements necessary to the operation of the express checkout vending machine 100, which further includes product storage, selection, and bagging components, for example.

The input unit 120 of the present invention preferably includes means for entering information into the express checkout vending machine 100. Suitable means of entering information require the capability to translate information held by a customer mentally or physically. Information held by a customer mentally is preferably transferred to the input unit 120 by a digital key pad, a digital touch pad, a voice interpreting device, or the like, as several examples known in the art, without any limitation intended. Information held by a customer physically can be included in the following examples, each presented in alternative embodiments without any limitation intended: (i) electronically in a chip or transponder of a smart card or a thumb drive; (ii) magnetically on media included in or on a diskette, cassette tape, or card, as in, for example, a magnetic strip included on a credit card; (iii) optically but not visibly on a compact disc or another object on which optical information has been burned; (iv) optically and visibly on an object in the form of a numeric code or a one- or two-dimensional bar code; and (v) the like. In some instances, the magnetic strip, barcode, or chip is included in or on an object. Such objects that can include such physically-based information include paper and cards made of various materials, such as, without limitation, paper and plastic.

In one embodiment of the present invention, the input unit 120 includes a reading device (not shown) that reads any of the information-bearing phenomena set forth above, and preferably the reading device reads at least two of the information-bearing phenomena set forth above or the express checkout vending machine 100 includes multiple reading devices that each read at least one or more of the information-bearing phenomena. More preferably, the reading unit reads at least a magnetic strip, a barcode, or a chip. Yet more preferably, the reading unit reads at least two of a magnetic strip, a barcode, and a chip. Even more preferably, the reading unit reads all three of a magnetic strip, a barcode, and a chip. As one example of a reading device that can be included in the present invention, one can employ a barcode scanner (not shown, but can be part of the coupon scanner unit 251a or 251b) as known in the art.

One embodiment of the express checkout vending machine 100 further includes a coupon scanner unit 251a that is preferably operably connected to the input unit 120. Operably connected as used in this context preferably signifies electronic, optic, or magnetic communication sufficient for the transfer of the included information of whatever information-containing object is read by the input unit 120. In another embodiment, the coupon scanner unit 251b is instead or in addition operably connected to a payment and receipt device 252. Preferably, the coupon scanner unit 251a, 251b is a single element that is connected to both the payment and receipt device 252 as well as to the input unit 120, although in other preferred embodiments the coupon scanner unit function is provided by separate components of the invention.

The payment and receipt device 252 receives payment, preferably by employing a magnetic strip reader or a chip reader for reading objects that include a magnetic strip and/or a chip, where the magnetic strip or chip contains the relevant payment information that would be part of a credit card, debit card, or a smart card, as appropriate. A customer intending to make a purchase would cause his or her card to come into contact with the payment and receipt device 252, which would then read the information using its included reader. The information is then communicated to the receipt and payment processing unit 253, where the information is processed by accessing memory included in the internal storage unit 254 for information relating to cost, as may be included in the product UPC and slot information 255 component of the express checkout vending machine 100. The receipt and payment processing unit 253 also accesses, as needed, information stored on the store's computer/server 256, the store's website 257, and/or the store's point of sale system 258 by communicating via communication unit I 250 and communication unit II 259. In that manner, the receipt and payment processing unit 253 will have up-to-date information on costs, sales, promotions, and the like, as well as provide information on the purchasing customer and his/her accounts for appropriate payment and control. Upon payment, the payment and receipt device 252 then dispenses a receipt. Accordingly, in some embodiments, the express checkout vending machine 100 further includes a physical printer (not shown) that, in one embodiment, is operably connected to the receipt and payment processing unit 253. The receipt and payment processing unit 253 can then issue a physical receipt that is issued to the customer as a printed paper. In other embodiments, the receipt can be issued electronically as, for example, a pdf file that is emailed to the customer by way, for example, of the store's computer server 256 connected to the store's communication unit 259.

The express checkout vending machine 100 further includes an internal storage unit 254, where information is stored regarding the products displayed and sold in the express checkout vending machine 100. The product information 261 component of the internal storage unit 254 may include product specifications, other products with which the displayed and inquired about product is usefully employed or with which the displayed product is incompatible, as well as a plethora of other information as may be available for each displayed product. This information can be shown on the output unit 130 upon being called up by the customer making a request therefor on the input unit 120. Information for a given product need not only be stored in the product information 261 module of the internal storage unit 254, but may also be accessed from the stores website 257, the store's computer/server 256, as well as other sites on the internet that the store's computer/server 256 may access. Among the information that, in some embodiments, may be accessed is competitive information about alternative products to that displayed as well as prices of the same product at competitors' stores.

One of the components of the express checkout vending machine 100 introduced earlier is the dispensing unit 110. As stated, the dispensing unit 110 is adapted to receive and internally bag self-purchase items, i.e., a displayed product that is selected for purchase by a customer is placed into a bag, optionally with a receipt provided by the payment and receipt device 252. Accordingly, what emerges from the express checkout vending machine 100 is the purchased product already in a bag thus signifying that it is a purchased item. In some embodiments of the present invention, the product bagging function is facilitated by a product vending and packaging unit 262, which is in electronic communication with the receipt and payment processing unit 253.

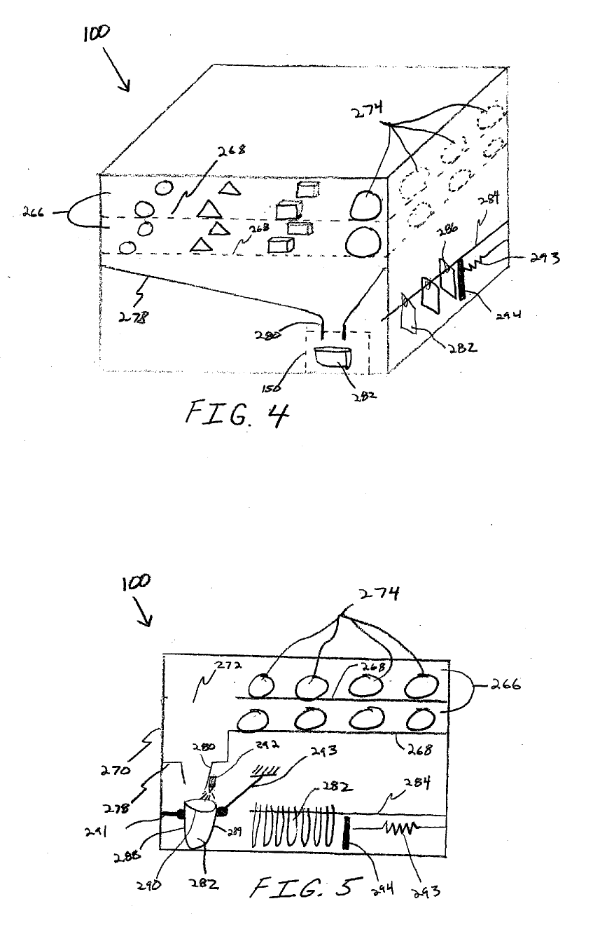

In one embodiment of the present invention, the product vending and packaging unit 262 can receive a product from an internal storage compartment 266. The internal storage compartment 266 is located near the top of the vending machine 100 in this embodiment and may have a plurality of levels 268 as shown in FIG. 4. Each level 268 may extend the entire length of the vending machine 100 or may extend for less than the entire length such that a gap 272 may exist between an end of the level 268 and a front outer wall 270 of the vending machine 100. Each level 268 preferably has a plurality of rows 274 of products in embodiments designed to hold and vend multiple products, wherein each row 274 may be composed of a different type of product. The internal storage compartment 266 is accessible by, in one embodiment, removing the front outer wall 270 of the vending machine 100. In such a configuration, the vending machine 100 may be re-filled with products without having to remove the vending machine 100 from a store shelf on which the vending machine 100 may be disposed. The means for fastening the front outer wall 270 to the vending machine 100 may be “tamperproof” designed in order to reduce the likelihood of theft of products stored in the internal storage compartment 266.

In one embodiment, the vending machine 100 has a transporting mechanism for moving the products in a row 274 toward the gap 272 such that a product is caused to fall, under gravity, into the gap 272. Such a transporting mechanism is well known in the art and therefore it is not described in significant detail in this specification. For example, the transporting mechanism may be a rotating auger aligned along and contacting a row 274 of products. Rotation of the auger may move the row 274 of products toward the gap 272. Alternatively, the transporting mechanism may be a conveyor belt disposed beneath a row 274 of products that moves the row 274 toward the gap 272. Alternatively, the transporting mechanism may be an actuating piston located at the rear of a row 274 that pushes the row 274 toward the gap 272. The transporting mechanism may be powered by an electro-motor that may be electronically controlled by the receipt and payment processing unit 253. For example, a user may enter information into the input unit 120 relating to a desired product. The receipt and payment processing unit 253 may identify the particular row 274 in which the desired product is located and activate the transporting mechanism for that row 274 such that the desired product or desired products are pushed into the gap 272.

Once a product has been pushed into the gap 272 in the embodiment being described in particular here, it may fall, under gravity, until it lands on a chute 278. The chute 278 may be inclined and preferably has a low coefficient of friction such that the product may slide, under gravity, down the chute 278 and into a funnel 280. The funnel 280 may guide the product from the chute 278 into the vending and packaging unit 262. Alternatively, the chute 278 may not be inclined and instead may be a conveyor belt for moving the product toward the funnel 280. Such a conveyor belt for transporting a product from a storage area to a packaging area is described by U.S. Pat. No. 5,442,898 at col. 8, lines 29-33 and FIG. 2 thereof, which is incorporated by reference as to the identified portions.

The chute 278 provides a means to transport the product across the vending machine 100 to a location where the product vending and packaging unit 262 is disposed. Transporting a product to the funnel 280 may be required because a row 274 of products may be located on a side of the vending machine opposite to that of the product vending and packaging unit 262. A chute 278 with a conveyor belt may facilitate a reduced height of the vending machine 100 such that the vending machine 100 may fit on a store shelf. If the chute 278 requires a steep incline in order for a product to slide, under gravity, down the chute 278, the requirements of the chute 278 may increase the height of the vending machine 100. A chute 278 with a conveyor belt may be flat and, therefore, may not require an increase in height of the vending machine 100.

Once a product has passed through the funnel 280, it may fall into a bag 282 located in the product vending and packaging unit 262. A plastic bag 282 may have a front wall 288, rear wall 289, and a mouth 290. In one embodiment, the vending and packaging unit 262 has a plurality of plastic bags 282 stacked along a wicket pin 284 as shown in FIG. 5. The wicket pin 284 may pass through a hole 286 located at the top of each plastic bag 282 such that the plastic bags 282 may hang from the wicket pin 284. Rather than hanging the plastic bags 282 along a wicket pin 284, the plastic bags 282 may be attached end-to-end in the form of a sheet and stored in a roll (not shown) as described in U.S. Pat. No. 6,112,539 at col. 5, lines 20-23 and FIG. 6, which hereby is incorporated by reference as to the noted portions.

An opening mechanism 291 may grip the front wall 288 of the plastic bag 282 and pull it away from the rear wall 289 of the plastic bag 282. In this manner, the opening mechanism 291 may open the mouth 290 of the plastic bag 282 such that the product can fall into the plastic bag 282. Bag opening mechanisms are generally known to those skilled in the art and thus are not be described in significant depth in this specification. For example, the opening mechanism 291 may be a vacuum cup that attaches by suction to the front wall 288 of the plastic bag 282 as described in U.S. Pat. No. 6,394,309 at col. 2, lines 64-66 and FIG. 1, which hereby is incorporated by reference as to the noted portions. Another example of an opening mechanism 291 is a pivotable arm that enters the mouth 290 of the plastic bag 282 and pushes outwards the front wall 288 as described in U.S. Pat. No. 5,442,898 at col. 8, lines 7-16 and FIG. 5C, which hereby is incorporated by reference as to the noted portions.

A burst of air may be supplied by a nozzle 292 attached to the funnel 280 as the opening mechanism 291 pulls open the front wall 288 of a plastic bag 282. The burst of air may expand the plastic bag 282 facilitating entry of the product as it falls to the bottom of the plastic bag 282. The nozzle 292 may use a solenoid to open and close an air valve and may be computer controlled. The equipment necessary for providing a burst of air to open a plastic bag 282 is known to those skill in the art and is described in U.S. Pat. No. 5,442,898 at col. 7, lines 17-26 and FIG. 5C, U.S. Pat. No. 6,394,309 at col. 3, line 63, and U.S. Pat. No. 4,989,391 at col. 3, lines 6-22, each of which hereby is incorporated by reference as to the respective noted portions.

A clamping mechanism 293 may hold the rear wall 289 of the plastic bag 282 in a fixed position as air is blown into the plastic bag 282 and/or as the product falls into the plastic bag 282. An example of a clamping mechanism 293 is described U.S. Pat. No. 5,442,898 at col. 8, lines 43-47, which hereby is incorporated by reference as to the noted portion. Once the vending machine 100 has dispensed a product within a plastic bag 282, a new plastic bag 282 may be pushed into a position such that the opening mechanism 291 can grip the front wall 288 of the plastic bag 282. A spring 293 attached to a plate 294 located at the rear of the plastic bags 282 on the wicket pin 284 may push the new plastic bag 282 into position.

In other embodiments, the express checkout vending machine 100 also includes a means for sealing the bag into which the purchased product is placed before dispensing. The bag used in the context of the present invention is a flexible material that is amenable to containing a variety of sizes and shapes of product or product packaging. The bag used for the present invention is also amenable to various sealing technologies, as described further below. The bag is not a hard plastic that is formed to hold a single variety of product, as, for example, in the instance of jewel cases used to contain compact discs. Preferably, the sealing means is operably connected to the product vending and packaging unit 262. In one embodiment, the sealing means seals the bag using any suitable sealing method, including both chemical and physical methods. For example, the sealing means can include an adhering material that is applied to the bag as it is folded such that the adhering material is applied between a portion of the outside surface of the bag and the last fold of the bag opening causing the folded opening to adhere to the side of the bag. Suitable adhering materials are well known in the art, including a variety of chemicals generically referred to as glue, among many other adhesives. U.S. Pat. No. 6,394,306 at col. 3, lines 31-34, which hereby is incorporated by reference as to the noted portion, describes one example of using adhesives to seal a bag. A physical approach involves use of a meltable bag material, placing the “neck” of the bag between the purchased product and the opening of the bag in contact with heated elements of a heat-sealer, thereby fusing shut the bag above the product and below the opening. U.S. Pat. No. 4,989,391 at col. 4 lines 24-31, and U.S. Pat. No. 6,112,539 at col. 5, lines 26-29, each of which hereby is incorporated by reference as to the respective noted portions, describe examples of using heat to seal a bag. An alternative physical method can employ a laser for fusing the neck of a bag composed of a fusible material. Yet another alternative involves the use of shrink-wrap materials whereby the product is placed in the shrink-wrap material that is then treated by heat or other suitable energy source to effect the shrinking function of the material and hold securely to the product. Those skilled in the art of packaging can readily choose alternative materials and methods for sealing a bag containing a purchased product before it is dispensed to the customer. An approach that does not require use of a separate sealing means involves use of a bag that includes a patch of protected adhesive material that seals the bag upon folding the bag appropriately and causing the adhesive material to be available for maintaining the bag in a closed state.

In one embodiment of the express checkout vending machine, the user removes a product that has been bagged and sealed from the vending machine 100 through the port 150. The port 150 may be located at the bottom of the vending machine adjacent to the vending and packaging unit 262. The port 150 may be manufactured from a transparent material such that the user can observe the bagging and sealing of the product. The bottom edge of the port 150 may be pivotally connected to the vending machine 100. A user may open the port by pulling on a handle 296 attached the exterior of the port 150 near the top edge of the port 150. A motor may automatically close the port 150 after a user has removed the bagged and sealed product. In one embodiment, the port may form a 45 degree angle when in a fully open position. This may prevent a user from reaching inside the port 150 in an attempt to remove products from the internal storage compartment 266. In another embodiment, the port 150 may be slidably connected to the front outer wall 270. In this configuration, a user may manually slide the port 150 to an open and/or closed position. The port 150 preferably has a locking mechanism (not shown) that is electronically controlled by the receipt and payment processing unit 263. The locking mechanism may use a solenoid and other equipment generally known to those skilled in the art. A sensor (not shown) can identify when the port 150 is in an open and/or closed position and may communicate such information to the receipt and payment processing unit 253. The receipt and payment processing unit 253 controls the locking mechanism and causes it to remain locked unless the user has inputted proper payment into the vending machine 100 for the desired product. The receipt and payment processing unit 253 also controls the product vending and packaging unit 262, instructing it not to bag and/or seal a product unless the port 150 is in a closed and locked position.

The express checkout vending machine 100 includes the communication unit I 250 for having operable communication with, among other points, the point of sale (POS) system 258 that is owned or associated with the store. With that communication, the customer is able to complete a transaction and take the purchased product. The POS system 258 takes the customer information and checks that the offer of purchase is based on a valid credit card, debit card, gift card, smart card, or the like, wherein the customer may have had to input additional information into the input unit 120, such as a personal identification number (PIN), the expiration date of the card, or the like. POS systems are generally known in the art and are available as commercial software packages, for example.

In one embodiment of the express checkout vending machine 100, the communication unit I 250 and communication unit II 259 are one and the same, where communications from the express checkout vending machine 100 is directly connected to the store's computer/server 256. Irrespective whether one or two communications units are employed, in this embodiment at least the communication unit I 250 is operably connected to the input unit 120, the video display screen 130, the internal storage unit 254, the receipt and payment processing unit 253, the store's website 257, and the POS system 258. In many embodiments of the present system, the communication unit(s) employ(s) wireless communications; preferably, communication unit I 250 employs wireless communications, as generally known in the art.

In certain embodiments of the present invention, the express checkout vending machine 100 also includes a means for deactivating a security feature on the product purchased, presuming that the product includes a security feature needing deactivation. There are many different security features used in controlling product in a store setting. Accordingly, among suitable deactivating means employed in the element deactivation of store security feature on purchased product 260, certain embodiments of the invention will include use of a detectable device on product where sensors thereof that are stationed at exits of the store or at other points within the store, for example, can be remotely set to energize an alarm, or not, when the detectable device is sensed. Alternatively, the detectable device placed on a product can be rendered undetectable by external sensors situated elsewhere in a store by placing the product's detectable device on a surface that, for example, serves to demagnetize the detectable device or otherwise impacting the detectable device thereby rendering it undetectable by the external sensors. Suitable detectable devices include transponders that emit a signal in response to a set radio frequency, and the like, among many other such designs known in the art.

The express checkout vending machine in some embodiments includes a further level of security for a store. In such embodiments, upon sealing of the bag the closure of the bag completes a simple electric circuit that serves to disable a security feature detectable in a store. When a customer opens the bag, the simple electric circuit is broken and sensors employed in the store can pick up that fact. The reason it may be important to have a signal detected in the event a sealed bag containing a vended product is that management knows that such a sealed bagged product was paid for. Accordingly, a shoplifter could take another item from the store and add it to an opened bag from the express checkout vending machine and think that management would not think to check the content of the bag for an illicit addition. However, if opening the bag creates a detectable signal, then the store security will know that checking the content of the bag would be a reasonable request. The circuit would be preferably irretrievably broken and alert security that there may be a problem in the event that the bag had been opened.

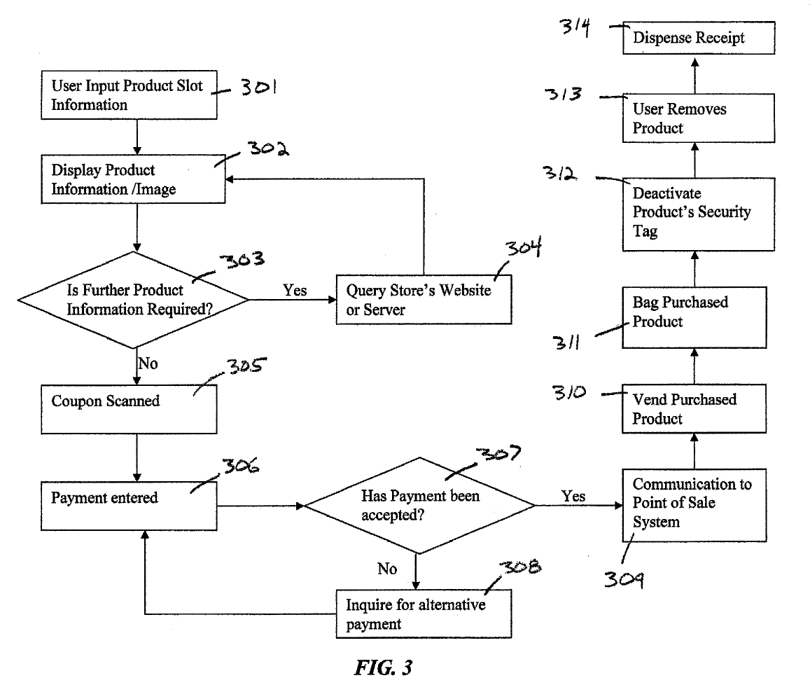

FIG. 3 displays a flow chart describing how a user may obtain a product from the vending machine 100 in one embodiment of the present invention. First, as shown in step 301, a user may enter information into the input unit 120 relating to a product the user intends to purchase. The user may input information in any manner that is appropriate for the type of input unit 120 used by the vending machine 100. For example, if the input unit 120 is a keyboard or a touch sensitive surface, the user may type information relating to the product into the input unit 120 or the user may touch an image displayed on the input unit 120 relating to the product. Alternatively, if the input unit 120 is a microphone, the user may enter information relating to the product by speaking into the input unit 120. Alternatively, if the input unit 120 is bar code scanner, the user display a bar code to the input unit 120 such that the bar code may be scanned by the input unit 120. The information entered by the user may not correspond exactly to the desired product but, instead, may correspond to a broad class of products to which the desired product belongs.

After the vending machine 100 processes information entered by the user, the output unit 130 may display information corresponding to the product that the user intends to purchase, as shown in step 302. The output unit 130 may display information relating to the product in graphical, textual, and/or audio form. The information presented by the output unit 130 may be, but is not limited to, any and all information commonly included on standard product packaging, including detail sometimes referred to as back panel information. This information may be stored in the internal storage unit 254 of the vending machine 100. If the user has entered information relating to a broad class of products to which the desired product belongs, the output unit 130 may display several products from which a user may select a single product by using the input unit 120.

Next, the output unit 130 may ask the user if further information relating to the product will be required, as shown in step 303. If the user enters an affirmative command in the input unit 120, the communication unit I 250 may query an external website and/or server for additional information regarding the product, as shown in step 304. Such additional information may relate to competitive alternative products. The additional information may then be displayed on the output device 130 for review by the user, as shown in step 302.

After the user has selected a product, the output unit 130 may prompt the user to enter information relating to possible discounts, such as a manufacturer's coupon, that may be entered by displaying the coupon to the coupon scanner unit 251, as shown in step 305. If available, the customer may also input information relating to a customer loyalty program. Then, the output unit 130 may prompt the user to confirm the purchase and make a required payment. In response, as shown in step 306, the customer may choose a form of payment including, for example, credit or debit using a credit or debit or smart card inserted into the appropriate slot for reading of same or keying in said information in the input unit 120, if the store accepted such information in that format, or cash using currency inserted into a slot for accepting cash.

After processing information regarding the payment, the receipt and payment processing unit 253 may decide if the payment is acceptable, as shown in step 307. If the user has chosen a credit or debit or smart card to purchase the product, the receipt and payment processing unit 253 may communicate with the point of sale system 258 which may have the ability to confirm whether the user has sufficient funds to make the purchase. If the form of payment is insufficient, the output unit 130 may prompt the user to enter another form of payment, as shown in step 308.

After an acceptable form of payment has been entered, the receipt and payment processing unit 253 may communicate sale information regarding the purchase to the point of sale system 258 via communication unit I 250, as shown in step 309. Such sale information may include identity of the user, type of product purchased, quantity of the product purchased, and date of the purchase. Furthermore, the point of sale system 258 may communicate updated information on costs, sales, or promotions to the payment processing unit 253 such that the user is charged an appropriate price for the product.

After the user has confirmed the purchase, the vending machine may vend the purchased product, as shown in step 310. In one embodiment, vending the purchased product may include physically moving the purchased product from the internal storage compartment 266 to a bag located in the product vending and packaging unit 262. For example, the dispensing unit 110 may have a rotating auger that moves the purchased product from the internal storage compartment 266 to the product vending and packaging unit 262. Alternatively, the dispensing unit 110 may have a servo mechanism with an actuating piston that pushes the purchased product from the internal storage compartment 266 to the product vending and packaging unit 262. In such a configuration, the internal storage compartment 266 may be located above the product vending and packaging unit 262 such that the actuating piston pushes the purchased product out of the internal storage compartment 266 thereby causing the purchased product to fall, under gravity, into the into the product vending and packaging unit 262. Alternatively, the dispensing unit 110 may have a conveyor belt that moves the purchased product from the internal storage compartment 266 to the product vending and packaging unit 262.

After the purchased product has been placed in the bag located in the product vending and packaging unit 262, the product vending and packing unit 262 may seal the bag, as shown in step 311. The bag may be sealed by using an adhesive, heating the bag's “neck” to fuse shut the bag, shrink-wrapping the bag, and/or fastening shut the bag. After the product has been bagged, the internal dispensing unit 110 may deactivate a security device located on the purchased product, as shown in step 312. For example, the internal dispensing unit 110 may generate an electromagnetic field that deactivates the security device located on the purchased product.

Next, the user may remove the bagged purchased product from the internal dispensing unit 110, as shown in step 314. In one embodiment, step 314 may involve opening a door and/or latch located on the exterior of the vending machine 100 thereby giving the user access to the product vending and packaging unit 262 where the bagged purchased product is disposed. Finally, the vending machine 100 may print and dispense a receipt of the transaction for the user, as shown in step 314. In an alternative embodiment disclosed above, the receipt is printed and disposed with the purchased product within the bag prior to the bag being sealed. In such embodiments, the bag containing the product is substantially transparent so that one can view the product and the receipt through the bag.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. An express checkout vending machine adapted for shelf use in a store, comprising:
an input unit;
an output unit;
a communication unit; and
a dispensing unit adapted to receive and internally bag self-purchase items.

2. The express checkout vending machine of claim 1, wherein the input unit comprises a digital touch pad and a reading device that reads at least one of the group consisting of a magnetic strip, a barcode, or a chip.

3. The express checkout vending machine of claim 1, further comprising a coupon scanner unit operably connected to the input unit.

4. The express checkout vending machine of claim 1, further comprising a receipt and payment processing unit.

5. The express checkout vending machine of claim 4, further comprising a printer operably connected to the receipt and payment processing unit.

6. The express checkout vending machine of claim 5, further comprising a product vending and packaging unit.

7. The express checkout vending machine of claim 6, further comprising a sealable bag and a means for sealing the sealable bag that is operably connected to the product vending and packaging unit.

8. The express checkout vending machine of claim 7, wherein the communication unit links to a website or server that is owned or associated with the store.

9. The express checkout vending machine of claim 8, wherein the communication unit is operably connected to the input unit, the output unit, an internal storage unit, the receipt and payment processing unit, the store's website, and a point of sale system that is owned or associated with the store.

10. The express checkout vending machine of claim 9, further comprising a means for deactivating a security feature on product purchased from the express checkout vending machine.

11. An express checkout vending machine, comprising:
(a) a means for receiving and displaying self-purchase items;
(b) a means for bagging self-purchase items within the vending machine prior to bagged self-purchase items being dispensed; and
(c) a means for dispensing one or more bagged self-purchase items.

12. The express checkout vending machine of claim 11, further comprising a means for sealing a bag containing the self-purchase items prior to dispensing.

13. The express checkout vending machine of claim 12, further comprising a means for printing a receipt.

14. The express checkout vending machine of claim 13, further comprising a means for inserting a printed receipt into the bag prior to the bag being sealed and dispensed.

15. The express checkout vending machine of claim 11, further comprising a means for accepting cashless payments.

16. The express checkout vending machine of claim 11, further comprising means for displaying pictures.

17. The express checkout vending machine of claim 11, further comprising a means for communicating from the express checkout vending machine to a remote facility.

18. The express checkout vending machine of claim 11, further comprising a means for scanning barcodes, magnetic strips, transponding chips, or holograms.

19. A method for dispensing a self-purchase item, comprising:
(a) receiving a payment for the self-purchase item;
(b) placing into a bag the self-purchase item prior to dispensing; and
(c) dispensing one or more self-purchase items in the bag.

20. The method of claim 19, further comprising sealing the bag containing the self-purchase items prior to the self-purchase items being dispensed.

21. The method of claim 20, further comprising printing a receipt for the self-purchase item and inserting the receipt with the self-purchase item into the bag prior to the bag being sealed.

22. The method of claim 21, further comprising displaying information relating to the self-purchase item.

23. The method of claim 22, further comprising communicating between the express checkout vending machine and a remote facility.
